(19) United States
(12) Patent Application Publication
(10) Pub. No.: US 2010/0172713 A1
(43) Pub. Date: Jul. 8, 2010

(54) SELF LOCKING FLOATING FASTENER

(76) Inventor: Michael Louis Benson, Indianapolis, IN (US)

Correspondence Address: KRIEG DEVAULT LLP, ONE INDIANA SQUARE, SUITE 2800, INDIANAPOLIS, IN, 46204-2079, US

(21) Appl. No.: 12/643,065

(22) Filed: Dec. 21, 2009

Related U.S. Application Data
(60) Provisional application No. 61/203,892, filed on Dec. 30, 2008.

(51) Int. Cl. F16B 13/06

(52) U.S. Cl. 411/35

(57) ABSTRACT

The present invention discloses a self locking floating fastener. Further embodiments, forms, features, aspects, benefits, and advantages shall become apparent from the description and figures provided herewith.

### CROSS REFERENCE TO RELATED APPLICATIONS

The present application claims the benefit of U.S. Provisional Patent Application 61/203,892, filed Dec. 30, 2008, which is incorporated herein by reference.

### GOVERNMENT RIGHTS IN PATENT

This invention was made with Government support under FA8650-07-C-2803 awarded by United States Air Force. The Government may have certain rights in this invention.

### FIELD OF THE INVENTION

The present invention relates to a re-useable self locking floating fastener that may be used in place of rivets and the like.

### BACKGROUND

Threaded fasteners are used to fasten structure in many forms. Blind applications are defined by the lack of access to one side of the fastened structure i.e. when an individual can not torque a male fastener on one side and simultaneously place or hold a nut on the other side. One common method to alleviate this problem is to install a threaded insert into one side of the structure prior to assembly and then torque a male fastener into the insert. Another method is to use a rivet if the blind portion of the structure is too thin to install a threaded fastener into. One problem with using inserts is the initial cost in terms of manufacturing cost and labor required to precisely prepare the hole and install the insert. If the insert fails for any reason such as stripped threads the insert must be drilled out and the hole must be re-prepped before installing a new insert. Rivets are problematic in that they are only one use applications and must be drilled out if there is a problem with the rivet or if the structures require separation. In addition to the labor intensive costs associated with drilling out rivets or inserts there is also a possibility of foreign object damage (FOD) occurring with small pieces of drilled out metal entering sensitive areas of high value machines such a gas turbine engines and the like. The present invention addresses the problems associated with prior art fasteners by providing a novel and non-obvious solution for a reusable threaded fastener for blind installations.

### SUMMARY

The present invention discloses a self locking floating fastener. Further embodiments, forms, features, aspects, benefits, and advantages shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIGS. 1A-1D schematically depict a non-limiting example of a fastener in accordance with an embodiment of the present invention for clamping together two structures.

FIG. 2 schematically depicts the fastener of FIGS. 1A and 1B with a fastener component expanded to fasten the two structures together.

FIG. 3 is an exploded perspective view of a floating fastener according to the present invention;

FIG. 4 is cross sectional view of the floating fastener of FIG. 3 extending through a structure in an unlocked configuration; and

FIG. 5 is cross-sectional view of the floating fastener of FIG. 4 in a locked configuration.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention relates to a floating self locking fastener that can be inserted through a blind aperture and torque to a desired level. In one form, the floating self locking fastener is reusable. In one form, the floating self locking fastener operates to fasten separate components or structure of any conceived dimension together. In one aspect of present invention the floating fastener can be advantageously used to replace rivets in thin walled structures and the like.

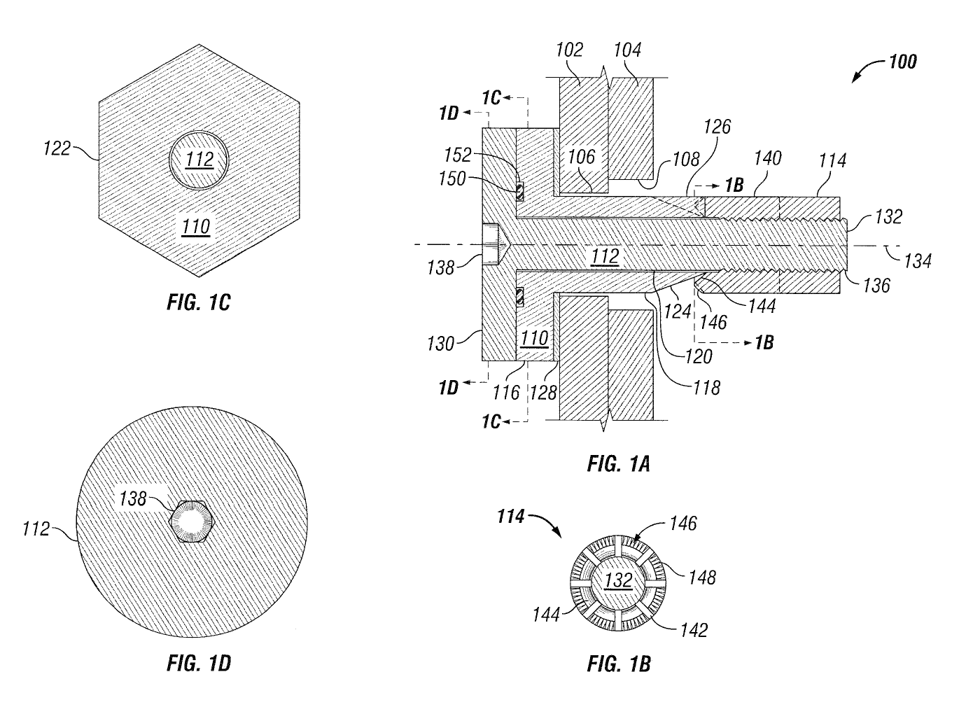

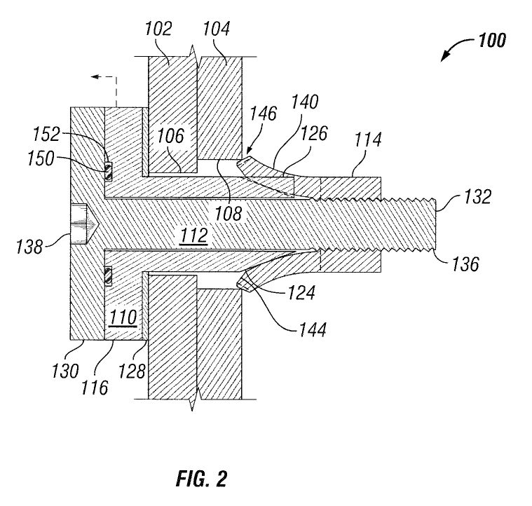

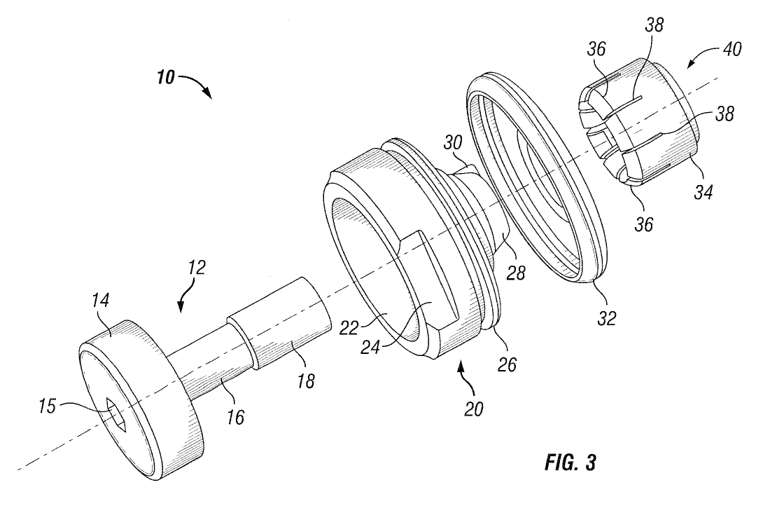

Referring now to FIGS. 1A-1D, a non-limiting example of a fastener 100 in accordance with an embodiment of the present invention is schematically depicted. In one form, fastener 100 is adapted for fastening two structures 102 and 104 together. In other embodiments, fastener 100 may be adapted for fastening together any number of structures. Structures 102 and 104 have respective holes 106 and 108 into which portions of fastener 100 are admitted. Holes 106 and 108 may or may not be the same size. Structures 102 and 104 may be any metallic or nonmetallic structures sought to be affixed to one another. In one form, structures 102 and 104 are metallic sheets. In other embodiments, structures 102 and 104 may take other forms.

In one form, fastener 100 includes a fastener component 110, a fastener component 112 and a fastener component 114. Fastener components 110, 112 and 114 may each take one or more of a variety of forms. Fastener components 110, 112 and 114 cooperate to fasten structures 102 and 104 together.

In one form, fastener component 110 includes an end 116, and end 118 and an opening 120. The geometric shape of fastener component 110 may take any of a variety of forms. End 118 is structured, e.g., geometrically dimensioned, for reception into both holes 106 and 108. End 116 is sized to prevent its entry into hole 106, and is located adjacent a front wall of structure 102. In one form, fastener component 110 includes a torquing feature 122 that is operative to transmit and/or react torque. In one form, torquing feature 122 is disposed on end 116. In one form, torquing feature 122 is a hex shape. In other embodiments, torquing feature 122 may take other forms. In other embodiments, torquing feature 122 may be disposed on end 118 in addition to or in place of end 116. In one form, torquing feature 122 is an anti-rotation feature operative to anti-rotate fastener component 110 relative to fastener component 112. In other embodiments, torquing feature 122 may be an anti-rotation feature operative to anti-rotate fastener component 110 relative to one or both of structure 102 and 104, e.g., such as a key that engages a slot in structure 102 and/or structure 104. Torquing feature 122 is operative to prevent the rotation of fastener component 110 upon the rotation of fastener component 112.

End 118 of fastener component 110 includes a ramp 124 for expanding fastener component 114. In one form, ramp 124 acts as a wedge to drive at least a portion of fastener component 114 radially outward. In one form, ramp 124 extends circumferentially around end 118 of fastener component 110. In other embodiments, ramp 124 may only be disposed at one or more locations around the circumference of end 118. End 118 also includes an anti-rotation feature 126 that is structured to engage an anti-rotation feature on fastener component 114 to anti-rotate fastener component 114 relative to fastener component 110. In one form, anti-rotation feature 126 is a key extending from ramp 124. In one form, a single key is employed, although the number of keys in other embodiments may vary with the application. In addition, in other embodiments, anti-rotation feature 124 may be positioned in other locations. Further, in other embodiments, anti-rotation feature 124 may take other forms, e.g., such as a slot that is structured to engage an anti-rotation feature, such as a key, on fastener component 114.

In one form, fastener 100 includes a resilient member 128. In one form, resilient member 128 is operative to seal against structure 102, e.g., against the front face or wall of structure 102 and/or hole 106. In one form, resilient member 128 is disposed adjacent end 116, e.g., opposite a head of fastener component 112. In other embodiments, resilient member 128 may be disposed in other locations, including in or on end 116 and/or end 118. In still other embodiments, fastener 100 may be devoid of resilient member 128. In still other embodiments, other members, resilient or not, may be employed in addition to or in place of resilient member 128.

Fastener component 112 includes a head 130 and an extension 132. Head 130 is structured, e.g., geometrically configured, to axially engage end 116 of fastener component 110 (the axial direction being a direction parallel to the center line 134 of fastener component 112, e.g., left-to-right in the depiction of FIG. 1A). Extension 132 is structured, e.g., geometrically configured, to be received into opening 120 of fastener component 110. In one form, extension 132 is a bolt shank with a threaded portion having threads 136. Threads 136 may extend partially or fully along the length of extension 132.

Fastener component 112 includes a torquing feature 138 that is operative to transmit and/or react torque. In one form, torquing feature 138 is disposed on head 130. In one form, torquing feature 138 is a hex socket. In other embodiments, torquing feature 138 may take other forms, including shapes extending into or out of head 130. Torquing feature 138 is operative to impart rotation to fastener component 112, e.g., via a tool or by hand.

Fastener component 114 is structured for driving engagement with extension 132 of fastener component 112. Fastener components 110, 112 and 114 are structured to translate fastener component 114 upon a rotation of fastener component 112. Fastener component 114 and end 118 of fastener component 110 are structured to expand at least a portion of fastener component 114 upon a translation of fastener component 114 toward and against, and impart both an axial clamp load against structure 104 and a radial load against hole 108.

In one form, fastener component 114 is a threaded nut configured to engage threads 136 of extension 132 of fastener component 112. In other embodiments, fastener component 114 may take other forms. In one form, fastener component 114 has a slotted end 140 with a plurality of slots 142 spaced apart circumferentially around fastener component 114. Although 8 slots are depicted in FIG. 1B, the number of slots may vary with the needs of the particular application. In the depiction of FIG. 1B, end 118 of fastener component 110 is not shown for purposes of clarity.

In one form, slots 142 are through-slots that extend through both the outer and inner diameters of slotted end 140. In other embodiments, slots 142 may only extend partially through the inner and/or outer diameters of slotted end 140.

Slotted end 140 is structured for engagement with fastener component 110 to both anti-rotate fastener component 114 relative to fastener component 110, and to expand slotted end 140 into engagement with structure 104. Slotted end 140 expands upon translation toward and onto end 118 of fastener component 110 under the action of ramp 124. In one form, slotted end 140 includes a ramp 144 operative to engage ramp 124 of fastener component 110. In other embodiments, slotted end 140 may not include a ramp. In one form, slotted end 140 includes a tip surface 146 operative to engage structure 104. In one form, tip surface 146 includes serrations 148. Serrations 148 may take any convenient form, e.g., knurls.

Fastener component 114 includes an anti-rotation feature that is structured to engage anti-rotation feature 126 of fastener component 110 to anti-rotate fastener component 114 relative to fastener component 110. In one form, the anti-rotation feature is a slot 142. In one form, a single slot 142 is employed as an anti-rotation feature, although the number of slots employed as anti-rotation features in other embodiments may vary with the needs of the particular application. In addition, in other embodiments, the anti-rotation feature of fastener component 114 may be positioned in other locations. Further, in other embodiments, the anti-rotation feature may take other forms, e.g., such as a key or other protrusion that is structured to engage an anti-rotation feature, such as a slot, on fastener component 110.

In one form, fastener 100 also includes a sealing member 150 disposed between and operative to seal between fastener component 110 and fastener component 112. In one form sealing member 150 is disposed between head 130 of fastener component 112 and end 116 of fastener component 110. In other embodiments, sealing member 150 may be positioned in other locations. In still other embodiments, fastener 100 may not include a seal for sealing between fastener component 110 and fastener component 112. In one form, sealing member 150 is disposed in a seal gland 152. In one form, gland 152 is formed in end 116 of fastener component 110. In other embodiments, gland 152 may be formed in desired locations on one or both of fastener components 110 and 112. Yet other embodiments may not include a gland for retaining sealing member 150.

Some aspects of a non-limiting example of an embodiment of the operation of fastener 100 are described thusly: Fastener components 110, 112 and 114 are assembled together, along with sealing member 150 and resilient member 128 for those embodiments so equipped. Fastener 100 is inserted into structures 102 and 104 via holes 106 and 108, e.g., until end 116 of fastener component 110 (or resilient member 128, for those embodiments so equipped) engages the front face of structure 102. Then, torque is applied to rotate fastener component 112 via torquing feature 138, while anti-rotating fastener member 110 with torquing feature 122. In other embodiments, fastener component 110 may be rotated, while anti-rotating fastener component 112 via torquing feature 122. In still other embodiments, both components 110 and 112 may be rotated, e.g., in opposite directions. The rotation of fastener component 112 relative to fastener component 110 results in the translation of fastener component 114 via the action of threads 136 of fastener component 112 engaging corresponding threads in fastener component 114, since fastener component 114 is anti-rotated relative to fastener component 110 via the engagement of key 126 with slot 140. The translation of fastener component 114 toward end 118 and onto ramp 124 of fastener component results in slotted end 140 expanding under the influence of ramp 124, increasing the diameter of slotted end 140. In one form, fastener component 114 is configured, in conjunction with fastener component 110, to expand in such a manner so as to intercept hole 108 with tip surface 146 of slotted end 140. Continued translation of fastener component 114 drives the serrated tip surface 146 of fastener component 114 into hole 108, e.g., at the corner established by the intersection of hole 108 with the back wall or face of structure 104, which imparts radial and axial loads to structure 104, and clamps structures 102 and 104 together between end 116 of fastener component 110 and slotted end 140 of fastener component 114. By providing serrations 148 in serrated end 140 of fastener component 114, the potential for loosening of fastener 100 in service may be reduced. Also, the need for anti-rotation of fastener component 110 during the final stages of assembly are reduced or eliminated in some embodiments, since fastener component 114 may be anti-rotated via serrations 148 “biting” into structure 104. In other embodiments, fastener 100 may be configured to provide only axial clamping loads between fastener component 114 and fastener component 110, with or without serrations.

Referring to FIG. 3, a non-limiting example of a floating self locking fastener 10 is in accordance with an embodiment of the present invention is illustrated therein. In one form, fastener 10 is a blind fastener, i.e., a fastener configured for use in a blind aperture, such as wherein access to the fastener is readily obtained only on one end. In one form, self locking fastener 10 includes a threaded bolt 12 having a head 14 with a drive socket 15 formed therein. The drive socket 15 can be in any form desired such as a recessed internal hex or a protruding connection. Furthermore, the drive socket 15 may be designed for standard tools or specially designed tools. A shank 16 extends from the head 14 and has a threaded portion 18 formed in the distal end thereof.

A bolt housing 20 includes a head pocket 22 for the head 14 of the bolt 12 to rest therein. The bolt housing 22 can include an anti-torque feature 24 operable for receiving in an anti-torque tool (not shown) to restrict the bolt housing 20 from rotating when the threaded bolt 12 is torqued down. The bolt housing 20 can optionally include a seal groove 26 for applications that require a fluid seal or a resilient abutment and the like. An optional seal or resilient member 32 can be positioned within the seal groove 26 if desired. A nut ramp 28 is formed on one end of the bolt housing 20 opposite of the head pocket 22. The bolt housing 20 includes at least one key 30 extending outward from the nut ramp 28.

A perforated nut 34 is designed to threadingly engage with the threaded bolt 12. The perforated nut 34 includes a plurality of expandable tabs 36 circumferentially extending around the perimeter of the nut 34. A plurality of slots 38 define the boundary between each tab 36. The nut 34 includes a threaded aperture 44 for engaging the threaded portion 18 of the bolt 12.

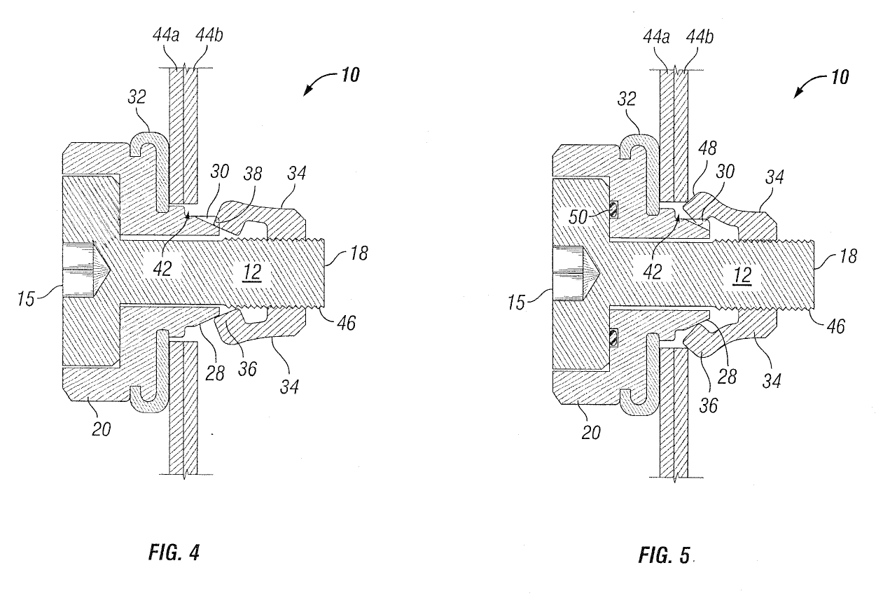

Referring now to FIG. 4, the nut 34 is threaded onto the threaded portion 18 of the bolt 12 after the bolt 12 has been inserted through the bolt housing 20. The nut 34 can be rotated down the threaded portion 18 until at least one slot 38 of the nut 34 engages with at least one key 30 of the bolt housing 20. The key 30 of the bolt housing 20 will prevent the nut 34 rotating relative to the bolt housing 20. The self locking fastener 10 can then be inserted through an opening 42 formed within structure having at least two walls 44a, 44b coupled together. After the fastener 10 is positioned within the through opening 42 the bolt 12 can be further torqued causing the nut 34 to move up the ramp 28 of the bolt housing 20 toward the wall 44b. As the nut 34 travels up the ramp 28 the expandable slots 36 will be elastically forced radially outward and an abutment edge 48 will engage the wall 44b an a manner that will hold the fastener 10 in place and prevent the walls 44a and 44b from separating as shown in FIG. 5. The threaded portion 18 of the bolt 12 can have deformable threads 46 to prevent the bolt 12 from inadvertently loosening after installation. A seal 50 can be positioned at an interface between the bolt head 14 and the head pocket 22 to prevent fluid from escaping through the interface.

Embodiments of the present invention include a fastener comprising a bolt having a drive head and a threaded shank extending therefrom; a bolt housing having a bolt receiving pocket adjacent one end and a nut ramp adjacent an opposing end; at least one key formed on the bolt housing proximate the nut ramp; and an expandable nut having at least two expandable tabs with a key receiving slot formed therebetween.

In a refinement, the fastener further comprises a resilient member disposed on the bolt housing between the bolt receiving pocket and the nut ramp.

In another refinement, the fastener further comprises a groove in the bolt housing for retaining the resilient member with the bolt housing.

In yet another refinement, the resilient member is a seal.

In still another refinement, the fastener further comprises a seal disposed in a seal gland formed in at least one of the bolt and the bolt housing, wherein the seal is operative to seal between the bolt and the bolt housing.

In yet still another refinement, the seal gland is disposed in the drive head.

In a further refinement, the bolt housing includes an anti-torque feature operative to transmit and/or react torque.

Embodiments of the present invention include a method of fastening at least two structures together comprising: sliding a threaded bolt through a bolt housing having a ramp with a key; torquing an expandable nut with at least two expandable tabs and a key slot formed therebetween onto the bolt until the key engages the key slot; positioning the fastener through an opening formed in the at least two structures; drawing the expandable nut up the ramp and expanding the tabs to engage a back wall of the one of the structures; and torquing the bolt to a desired torque level.

Embodiments of the present invention include a fastener for fastening at least two structures together, comprising: a first fastener component having a first end, a second end, and an opening extending through the first end and the second end, wherein the second end is structured for reception into both a first hole in a first structure of the at least two structures and a second hole in a second structure of the at least two structures; and wherein the first end is sized to prevent entry into the first hole; a second fastener component having a head and an extension adjacent to the head, wherein the head is structured to axially engage the first end of the first fastener component; and wherein the extension is structured to be received into the opening of the first fastener component; and a third fastener component structured for driving engagement with the extension of the second fastener component, wherein the first, second and third fastener components are structured to translate the third fastener component upon rotation of the second fastener component; and wherein the third fastener component and the second end of the first fastener component are structured to expand at least a portion of the third fastener component upon a translation of the third fastener component and impart both an axial clamp load against the second structure and a radial load against the second hole.

In a refinement, the second end of the first fastener component includes a ramp for expanding the third fastener component.

In another refinement, the extension of the second fastener component includes a threaded portion, and wherein the third fastener component is a nut.

In yet another refinement, the third fastener component has a slotted end structured for engagement with the first fastener component.

In still another refinement, the first fastener component has a first anti-rotation feature and the third fastener component has a second anti-rotation feature; and wherein the first anti-rotation feature and the second anti-rotation feature are operative to anti-rotate the third fastener component relative to the first fastener component.

In yet still another refinement, one of the first anti-rotation feature and the second anti-rotation feature includes a slot; and wherein the other of the first anti-rotation feature and the second anti-rotation feature includes a key structured to engage the slot to anti-rotate the third fastener component relative to the first fastener component.

In a further refinement, the first fastener component includes an anti-torque feature for preventing rotation of the first fastener component upon rotation of the second fastener component.

In a yet further refinement, the fastener further comprises a resilient member disposed adjacent to the first end of the first fastener component opposite the head of the second fastener component.

In a still further refinement, the fastener further comprises a sealing member disposed between the first end of the first fastener component and the head of the second fastener component.

In a yet still further refinement, the fastener further comprises a sealing member and a gland, wherein the gland is formed in at least one of the first fastener component and the second fastener component, wherein the sealing member is operative to seal between the first fastener component and the second fastener component.

In an additional refinement, the first fastener component has a first torquing feature operative to transmit and/or react torque; and wherein the second fastener component has a second torquing feature operative to transmit and/or react torque.

In another refinement, the third fastener component includes a serrated end operative to engage the second hole.

Embodiments of the present invention include a fastener for fastening at least two structures together, comprising: a first fastener component having a first end, a second end, an opening extending through the first end and the second end, and a first anti-rotation feature, wherein the second end is structured for reception into both a first hole in a first structure of the at least two structures and a second hole in a second structure of the at least two structures; and wherein the first end is sized to prevent entry into the first hole; a second fastener component having a head and an extension adjacent to the head, wherein the head is structured to axially engage the first end of the first fastener component; and wherein the extension is structured to be received into the opening of the first fastener component; and a third fastener component having a second anti-rotation feature operative to anti-rotate the third fastener component relative to the first fastener component, wherein the third fastener component is structured for driving engagement with the extension of the second fastener component, wherein the first, second and third fastener components are structured to translate the third fastener component upon rotation of the second fastener component to clamp the at least two structures together.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A fastener comprising:
a bolt having a drive head and a threaded shank extending therefrom;
a bolt housing having a bolt receiving pocket adjacent one end and a nut ramp adjacent an opposing end;
at least one key formed on the bolt housing proximate the nut ramp; and
an expandable nut having at least two expandable tabs with a key receiving slot formed therebetween.

2. The fastener of claim 1, further comprising a resilient member disposed on the bolt housing between the bolt receiving pocket and the nut ramp.

3. The fastener of claim 2, further comprising a groove in the bolt housing for retaining the resilient member with the bolt housing.

4. The fastener of claim 2, wherein the resilient member is a seal.

5. The fastener of claim 1, further comprising a seal disposed in a seal gland formed in at least one of the bolt and the bolt housing, wherein the seal is operative to seal between the bolt and the bolt housing.

6. The fastener of claim 5, wherein the seal gland is disposed in the drive head.

7. The fastener of claim 1, wherein the bolt housing includes an anti-torque feature operative to transmit and/or react torque.

8. A method of fastening at least two structures together comprising:
sliding a threaded bolt through a bolt housing having a ramp with a key;
torquing an expandable nut with at least two expandable tabs and a key slot formed therebetween onto the bolt until the key engages the key slot;
positioning the fastener through an opening formed in the at least two structures;
drawing the expandable nut up the ramp and expanding the tabs to engage a back wall of the one of the structures; and
torquing the bolt to a desired torque level.

9. A fastener for fastening at least two structures together, comprising:
a first fastener component having a first end, a second end, and an opening extending through the first end and the second end, wherein the second end is structured for reception into both a first hole in a first structure of the at least two structures and a second hole in a second structure of the at least two structures; and wherein the first end is sized to prevent entry into the first hole;
a second fastener component having a head and an extension adjacent to the head, wherein the head is structured to axially engage the first end of the first fastener component; and wherein the extension is structured to be received into the opening of the first fastener component; and
a third fastener component structured for driving engagement with the extension of the second fastener component,
wherein the first, second and third fastener components are structured to translate the third fastener component upon rotation of the second fastener component; and
wherein the third fastener component and the second end of the first fastener component are structured to expand at least a portion of the third fastener component upon a translation of the third fastener component and impart both an axial clamp load against the second structure and a radial load against the second hole.

10. The fastener of claim 9, wherein the second end of the first fastener component includes a ramp for expanding the third fastener component.

11. The fastener of claim 9, wherein the extension of the second fastener component includes a threaded portion, and wherein the third fastener component is a nut.

12. The fastener of claim 9, wherein the third fastener component has a slotted end structured for engagement with the first fastener component.

13. The fastener of claim 9, wherein the first fastener component has a first anti-rotation feature and the third fastener component has a second anti-rotation feature;
and wherein the first anti-rotation feature and the second anti-rotation feature are operative to anti-rotate the third fastener component relative to the first fastener component.

14. The fastener of claim 13, wherein one of the first anti-rotation feature and the second anti-rotation feature includes a slot; and wherein the other of the first anti-rotation feature and the second anti-rotation feature includes a key structured to engage the slot to anti-rotate the third fastener component relative to the first fastener component.

15. The fastener of claim 9, wherein the first fastener component includes an anti-torque feature for preventing rotation of the first fastener component upon rotation of the second fastener component.

16. The fastener of claim 9, further comprising a resilient member disposed adjacent to the first end of the first fastener component opposite the head of the second fastener component.

17. The fastener of claim 9, further comprising a sealing member disposed between the first end of the first fastener component and the head of the second fastener component.

18. The fastener of claim 9, further comprising a sealing member and a gland, wherein the gland is formed in at least one of the first fastener component and the second fastener component, wherein the sealing member is operative to seal between the first fastener component and the second fastener component.

19. The fastener of claim 9, wherein the first fastener component has a first torquing feature operative to transmit and/or react torque; and wherein the second fastener component has a second torquing feature operative to transmit and/or react torque.

20. The fastener of claim 9, wherein the third fastener component includes a serrated end operative to engage the second hole.

21. A fastener for fastening at least two structures together, comprising:
a first fastener component having a first end, a second end, an opening extending through the first end and the second end, and a first anti-rotation feature, wherein the second end is structured for reception into both a first hole in a first structure of the at least two structures and a second hole in a second structure of the at least two structures; and wherein the first end is sized to prevent entry into the first hole;
a second fastener component having a head and an extension adjacent to the head, wherein the head is structured to axially engage the first end of the first fastener component; and wherein the extension is structured to be received into the opening of the first fastener component; and
a third fastener component having a second anti-rotation feature operative to anti-rotate the third fastener component relative to the first fastener component, wherein the third fastener component is structured for driving engagement with the extension of the second fastener component,
wherein the first, second and third fastener components are structured to translate the third fastener component upon rotation of the second fastener component to clamp the at least two structures together.
